(19) United States
(12) Patent Application Publication
(10) Pub. No.: US 2009/0256318 A1
(43) Pub. Date: Oct. 15, 2009

(54) Device for Detachably Coupling Two Parts

(76) Inventor: Gerhard Stolz, Ingersheim (DE)

Correspondence Address: FLYNN THIEL BOUTELL & TANIS, P.C., 2026 RAMBLING ROAD, KALAMAZOO, MI, 49008-1631, US

(21) Appl. No.: 11/991,544

(22) PCT Filed: Sep. 13, 2006
(86) PCT No.: PCT/EP2006/008893

§ 371 Date: Mar. 5, 2008

(30) Foreign Application Priority Data
Sep. 13, 2005 (DE) 10 2005 043 850.4

(51) Int. Cl. B23B 31/107

(52) U.S. Cl. 279/28; 409/234; 408/239 R

(57) ABSTRACT

A device for coupling two parts includes a first part having a cylindrical adapting journal and a radial flat surface which limits the adapting journal by the base thereof and being radially protruded, and a second part having a receiving sleeve with a cylindrical internal surface. A clamping device, during clamping, enables the adapting journal to be inserted into the receiving sleeve and to be pressed thereto between the flat surface and a front surface. In order to guarantee an exact centering of the parts with the aid of simple means, the inventive receiving sleeve is provided with a lower conical part diverging from the internal cylindrical surface towards the front surface and the adapting journal is provided with an elastically deformable centering ring which is arranged at the level of the base and is provided with an external conical part complementary to the lower conical part.

The invention relates to a device for coupling two components, in particular two tool parts, having a locating pin which is arranged on the first component and has a substantially cylindrical lateral surface, and having a radially projecting annular planar face which delimits the locating pin at its root, having a receiving sleeve which is arranged on the second component and has a cylindrical inner face and is delimited by an annular end face, and having a clamping mechanism which pulls the locating pin into the receiving sleeve and, here, presses the planar face and the end face against one another, with the receiving sleeve having an inner cone part which diverges from the cylindrical inner face toward the end face, and with the locating pin supporting an outer cone part which is complementary thereto.

The coupling device according to the invention is designed primarily for detachably coupling tools to a machine spindle (interface) and for connecting tool parts to one another (parting point). “Tool parts” are to be understood in particular to mean bore rods, elongation and reduction pieces, adjusting heads, spindle ancillary flanges and machine spindles.

In known couplings of said type, the centering takes place by means of the cylinder fit of the locating pin in the receiving sleeve, while the rotary drive takes place predominantly by means of friction on account of the planar face clamping between the planar face and the end face. In cylinder fits, there is in principle always a certain radial play between the locating pin and receiving sleeve. In order to avoid said disadvantage, it has already been proposed (DE 102 33 694 A1) that the locating pin has, in the region of its root, an outer cone part which diverges from the cylindrical lateral surface to the planar face and which is integrally formed on the locating pin. In order to ensure sufficient planar face clamping for the rotary drive, it is proposed there above all that the inner cone part can be elastically expanded under the action of the clamping mechanism. For this purpose, a material weakening is required in the region of the end part of the sleeve, which is perceived to be disadvantageous.

The invention is based on the object of improving the known coupling device of the type specified in the introduction in such a way that good centering properties and sufficient planar face clamping for the rotary drive are ensured even without a material weakening in the sleeve region.

To achieve said object, the combinations of features specified in patent claims 1 and 26 are proposed. Advantageous embodiments and refinements of the invention can be gathered from the dependent claims.

The solution according to the invention consists primarily in that the locating pin supports, in its root region, an elastically deformable centering ring which has the outer cone part. The centering ring is expediently plugged onto the locating pin. In order to ensure precise positioning of the centering ring on the locating pin, the centering ring should be connected to the locating pin in a form-fitting and/or force-fitting manner. For this purpose, the locating pin can have an encircling open-edged recess for receiving the centering ring. If the centering ring is detachable from the locating pin, it can, in order to create compatibility with conventional clutch systems of said type, be removed from the locating pin. It is however fundamentally also possible for the centering ring to be shrunk onto the locating pin.

According to one preferred embodiment of the invention, the open-edged recess extends into an axial undercut in the planar face of the first component. Here, the open-edged recess has an oversize with respect to the centering ring, which permits the elastic deformation of the latter during the joining process. The centering ring is expediently composed of resiliently elastic material, preferably of spring steel.

A further preferred embodiment of the invention provides that the centering ring has an annular base part which is connected to the locating pin in a form-fitting, force-fitting and/or cohesive fashion, and an annular spring part which axially adjoins the base part, projects freely beyond the adjacent lateral surface of the locating pin and supports the outer cone part. Here, the centering ring can, with its base part, be latched, shrunk, adhesively bonded, welded and/or soldered onto the locating pin. The spring part is integrally formed either on that side of the base part which faces toward the locating pin root or on that side of the base part which faces away from the locating pin root. Accordingly, the spring part projects beyond the base part, which is fixed to the locating pin, either in the direction of the locating pin root or in the opposite direction.

Here, it is expediently proposed that the centering ring has an annular base part which bears against a cylindrical section of the locating pin, and a spring part which projects axially beyond the base part and engages into the open-edged recess. Accordingly, the locating pin has a cylindrical centering section which is arranged at an axial distance from the planar face, which cylindrical centering section is adjoined in the direction of the planar face, via a delimiting step, by the open-edged recess with smaller diameter than the centering section. Here, the centering ring is, with its base part, expediently plugged or shrunk onto the cylindrical section of the locating pin with fitting accuracy. For this purpose, the base part of the centering ring has a centering opening which is matched in diameter to the centering section of the locating pin and whose inner diameter is smaller than the diameter in the region of the spring part. Here, the inner diameter in the region of the spring part can vary over the axial extent of the centering ring. The undercut advantageously has a run-on bevel, which points obliquely in the direction of the component axis, for the spring part of the centering ring. During the joining process, the spring part migrates along the run-on bevel in the direction of the component axis. For this purpose, the centering ring has, in the region of the spring part, an annular bending zone formed by a material thinning. It is particularly advantageous in this context if the cone angle of the sleeve-side inner cone is, when the locating pin is loose, steeper than the cone angle of the centering-ring-side outer cone. In this case, during the joining process, the receiving sleeve abuts with the end edge of its inner cone firstly against the outer cone of the centering ring, so that the spring part can bend inward along the run-on bevel and the cone angle of the centering ring is gradually aligned with the cone angle of the outer cone. When the locating pin is clamped, there is finally areal contact between the inner cone of the receiving sleeve and the outer cone of the centering ring. A peculiarity of the construction according to the invention is that the centering, in the clamped state, is placed in contact at three points arranged at a distance from one another to form annular contact, specifically, in the region of the base part, at the inside against the centering section of the locating pin, in the region of the spring part, at the outside against the inner cone of the receiving sleeve, and in the region of the locating pin root, at the end side against an undercut face.

A further advantageous embodiment of the invention provides that a sealing ring, composed of elastomeric material, is enclosed between the locating pin and the centering ring, which sealing ring prevents the infiltration of dirt into the intermediate region. Here, the sealing ring can be integrally vulcanized either on the locating pin or on the centering ring.

In order to facilitate assembly of the centering ring, the latter can have a plurality of spreading slots which are arranged so as to be distributed over the periphery and are open axially toward the base part side and/or toward the spring part side. During the clamping process, the spreading slots ensure that the elimination of play at the contact points between the components with the interposition of the spreading ring is facilitated.

The cone angle of the inner and of the outer cone is expediently dimensioned such that no self-locking occurs. Said cone angle should therefore be at least 8°.

According to a further preferred or alternative embodiment variant in which the receiving sleeve and/or the locating pin have a cone part which diverges from its cylindrical lateral surface or inner face toward the end or planar face, which cone part is embodied as an inner cone part in the case of the receiving sleeve and as an outer cone part in the case of the locating pin, it is proposed according to the invention that an annularly encircling pocket which is formed into the receiving sleeve and/or into the locating pin is provided between the receiving sleeve and the locating pin in the region of the at least one cone part, in which pocket is arranged a cage ring which is composed of elastically deformable material and which is fitted with support bodies, preferably embodied as support balls, which are arranged so as to be distributed in the peripheral direction and which, in the joined state, are supported against the delimiting walls, which face towards one another in the region of the pocket, of the receiving sleeve and of the locating pin. Here, the cage ring is expediently composed of a polymer material which performs both a retaining function for the support balls and also a sealing function.

In order to facilitate the joining process, the cage ring is expediently connected in a form-fitting and/or force-fitting manner to one of the two components. For this purpose, the cage ring can be latched, clamped or screwed onto one of the two components. One preferred embodiment of the invention provides that the encircling pocket is formed into the receiving sleeve and the cage ring is fixed in said pocket. In this way, a situation is obtained in which retrofitting is necessary only on the side of the receiving sleeve.

Additionally, the measures according to the invention allow trisection to be generated over the length of the locating pin and of the receiving sleeve: the clamping mechanism is situated in the cylindrical part of the locating pin and of the receiving sleeve. The conical parts in the region of the centering ring and of the receiving sleeve ensure the centering. The planar face clamping which takes place under the action of the clamping mechanism effects the rotary drive. The asymmetry in the planar face clamping introduced by the clamping mechanism is compensated by the elastically compressible centering ring. With suitable dimensioning of the locating pin fit in the locating bore, during the clamping process, there is additionally contact between the bore wall and the locating pin and therefore an increase in the bending stiffness in the connecting region.

According to one preferred embodiment of the invention, the clamping mechanism has a clamping bolt which is movably arranged in a transverse bore of the locating pin and which has, at its ends, an inner or outer cone, and two clamping elements which are situated diametrically oppositely with respect to the cylindrical inner face of the receiving sleeve, which, during the clamping process, can be clamped in a wedged fashion to the clamping bolt under bending of the centering ring and under mutual pressing of the components in the region of the planar face, and which are preferably embodied as holding screws. In this way, a situation is obtained in which the planar face clamping is generated by the clamping bolts and the clamping bolts and the clamping elements, while the centering and stiffening of the coupling takes place by means of the cone parts on the centering ring and in the receiving sleeve. Tests have shown that the reproducibility in the joining process is significantly improved on account of the conical elimination of play by means of the centering in relation to the variant with an outer cone integrally formed on the locating pin. With the measures according to the invention, it is also possible for the rotationally symmetrical coupling faces of the first and second components in each case to be hard-turned and if appropriate ground in a precisely concentric fashion in a clamped machine support. This ensures a high degree of centering accuracy.

The above advantages can also be obtained when using a clamping mechanism which has a tension bolt which projects axially beyond the end-side end of the locating pin, and also a pull-in device which is arranged at the machine side and which engages axially on the tension bolt through a passage opening in the receiving sleeve.

The invention is explained in more detail below on the basis of the exemplary embodiments schematically illustrated in the drawing, in which:

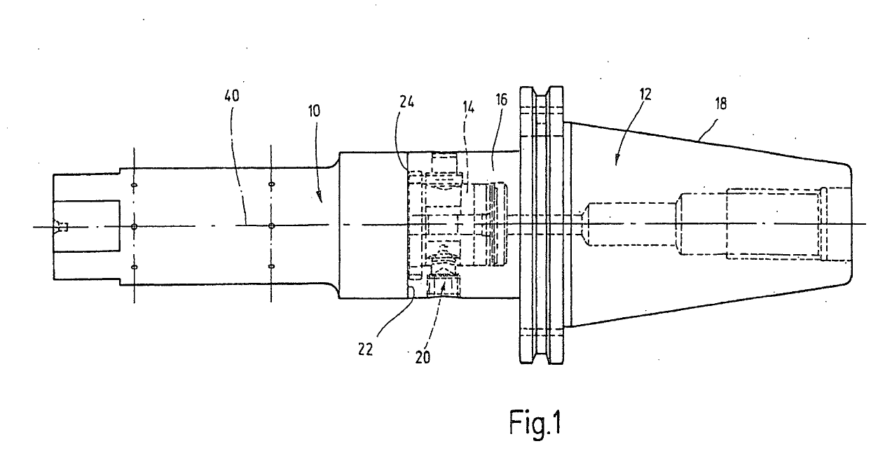

FIG. 1 shows a side view of two tool parts, which are coupled to one another, in the form of a measuring mandrel with adapter piece;

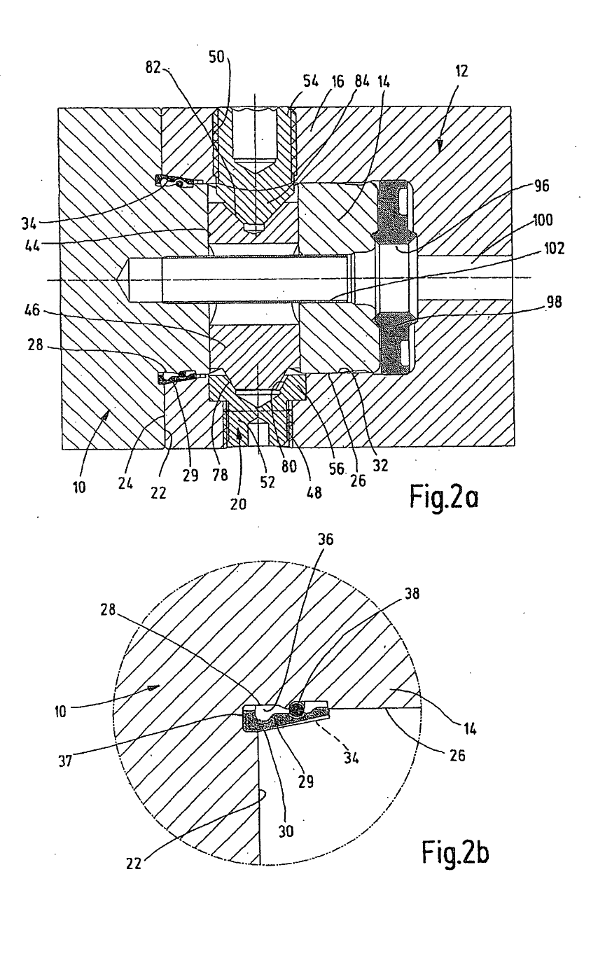

FIG. 2a shows a detail of a first embodiment variant of the coupling point between the two tool parts as per FIG. 1 in an enlarged section illustration;

FIG. 2b shows an enlarged detail from FIG. 2a;

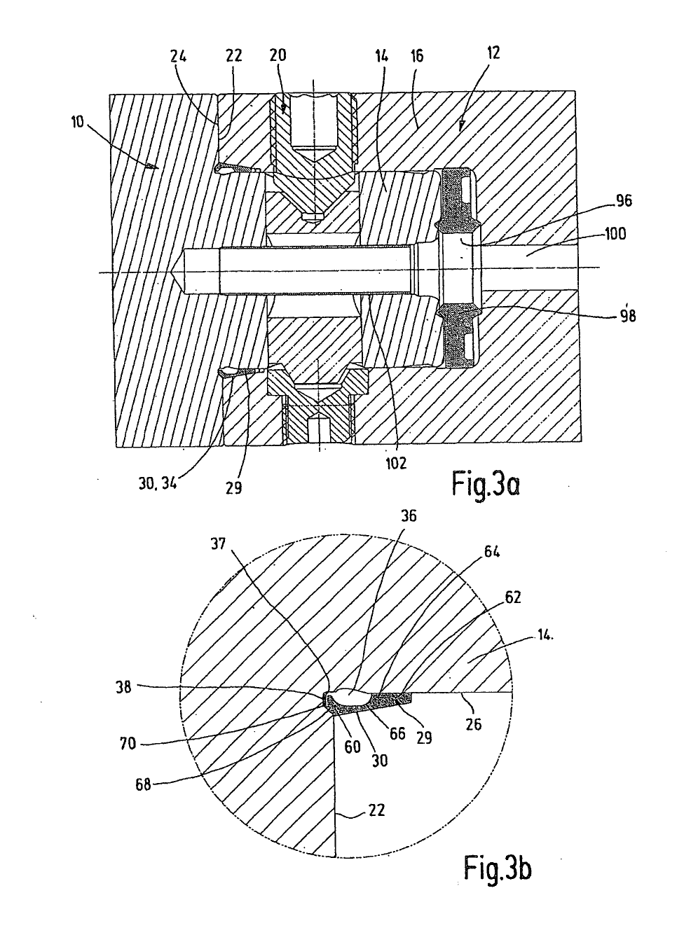

FIG. 3a shows a detail of a second embodiment variant of the coupling point between the two tool parts as per FIG. 1 in an enlarged section illustration;

FIG. 3b shows an enlarged detail from FIG. 3a;

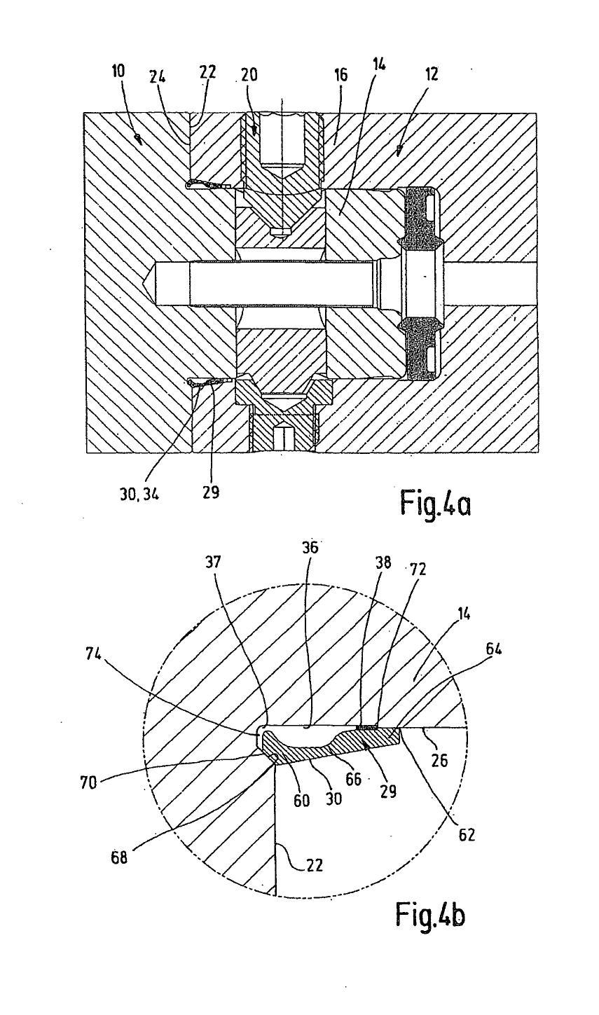

FIG. 4a shows a detail of a third embodiment variant of the coupling point between the two tool parts as per FIG. 1 in an enlarged section illustration;

FIG. 4b shows an enlarged detail from FIG. 4a;

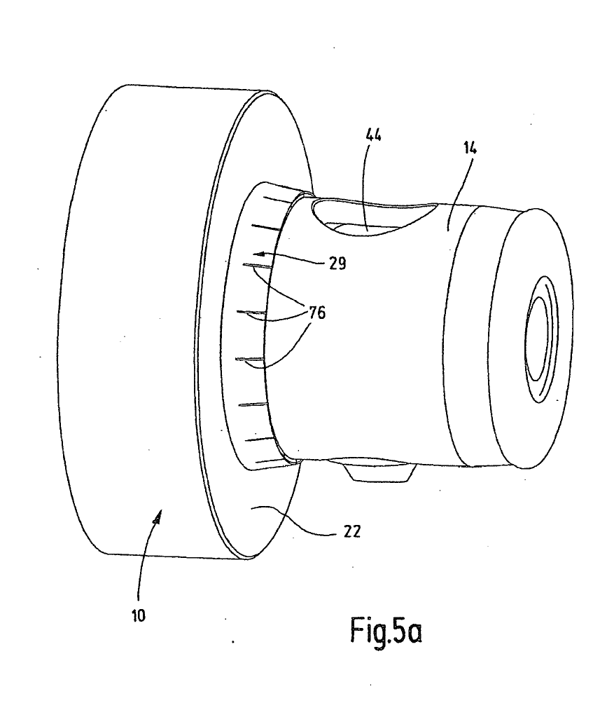

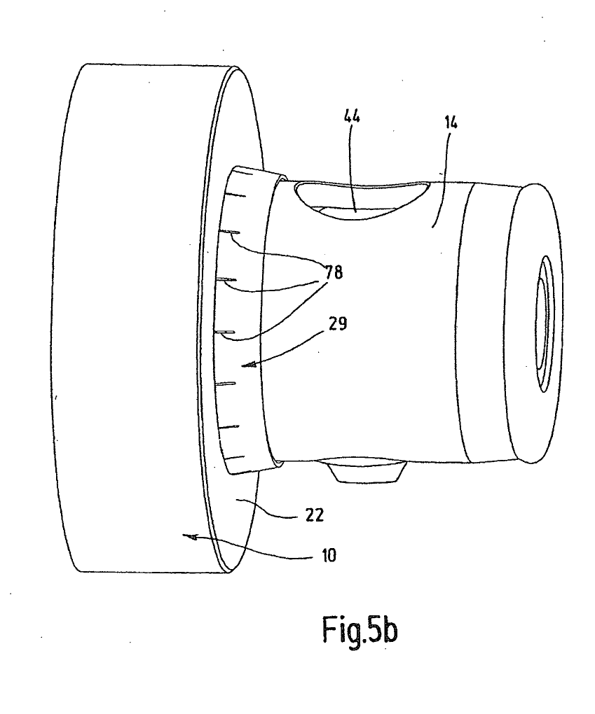

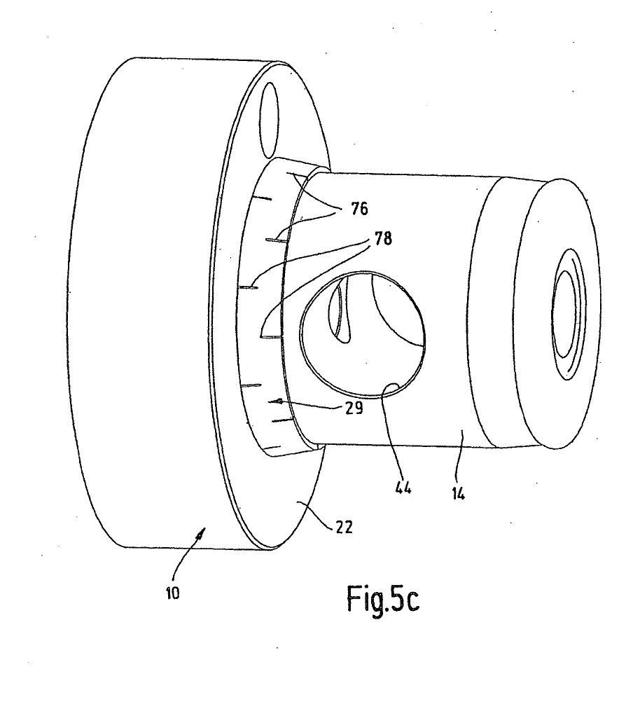

FIGS. 5a to c show three embodiment variants of the workpiece fitted with the locating pin, with three differently-designed centering rings, in a diagrammatic illustration;

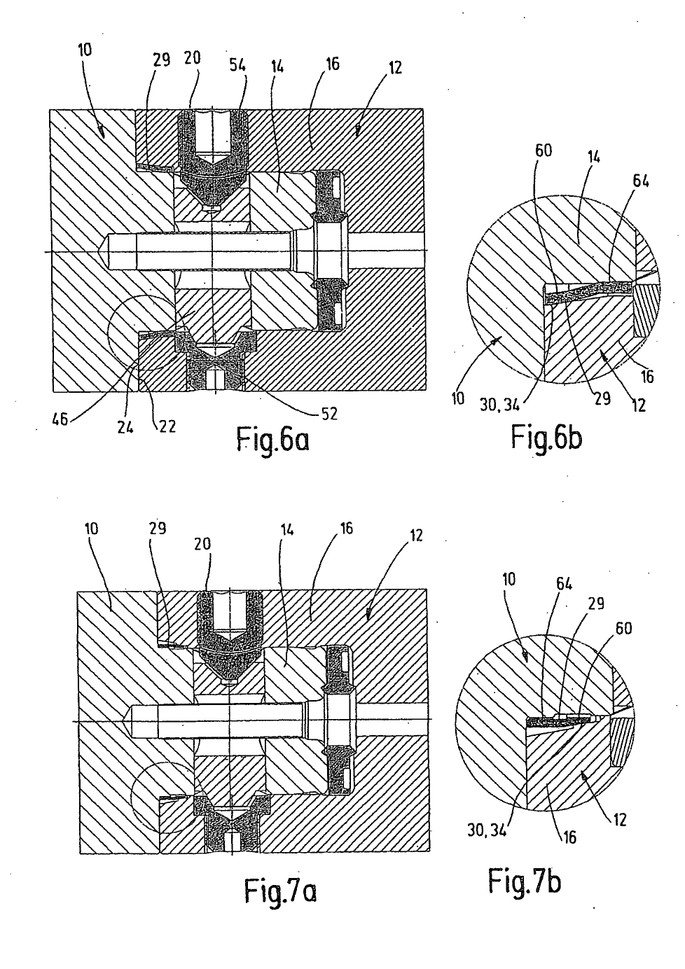

FIGS. 6a and b to

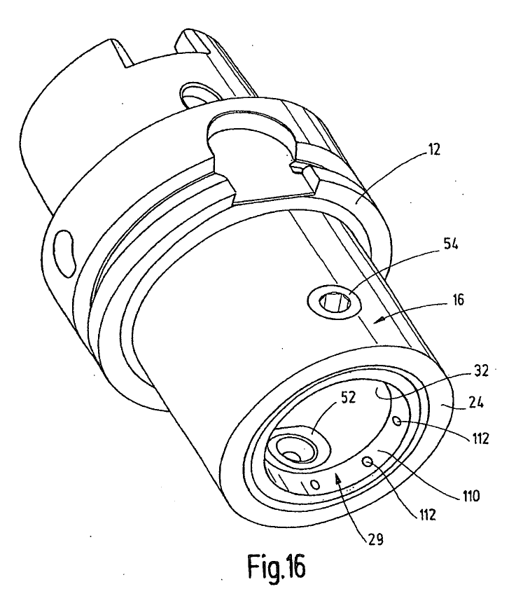

FIGS. 15a and b show some further embodiment variants of the coupling point between the two tool parts in section illustrations corresponding to FIGS. 2a and b;

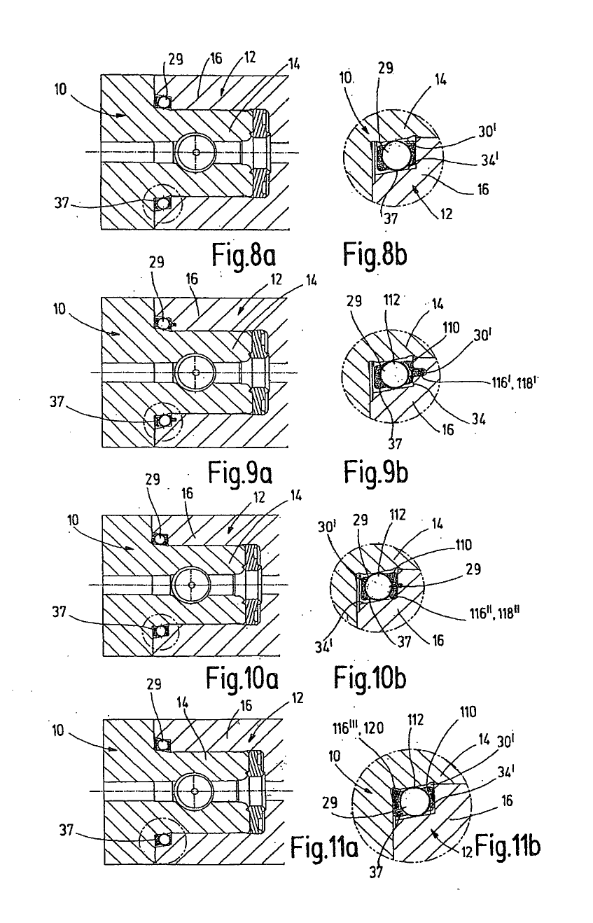

FIG. 16 shows an adapter piece in a diagrammatic illustration with a receiving sleeve corresponding to one of the embodiment variants as per FIGS. 8a and b to 15a and b;

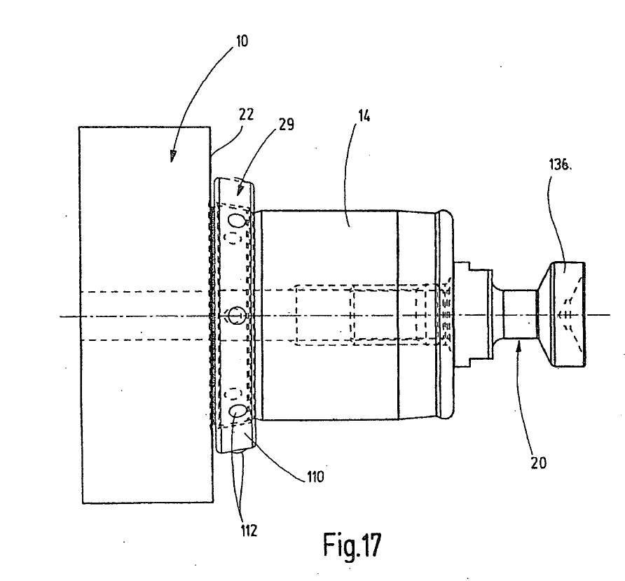

FIG. 17 shows a side view of a tool part with a locating pin and tension bolt, and a schematically illustrated cage ring as per the exemplary embodiment as per FIGS. 8a to 15b.

The connecting devices illustrated in the drawing serve for detachably connecting components 10, 12. Below, “components” are to be understood to mean primarily tool parts which contain either a locating pin 14 or a receiving sleeve 16. In the exemplary embodiment shown in FIG. 1, the component 10 which is fitted with the locating pin 14 is a measuring mandrel, while the component 12 which is provided with the receiving sleeve 16 is an adapter piece with a steep cone shank 18 for the connection to a machine spindle.

The connecting device is composed substantially of a locating pin 14 which projects axially beyond the first component 10, a receiving sleeve 16 which is arranged on the second component, and a clamping mechanism 20 for pulling the locating pin 14 into the receiving sleeve 16 and for generating planar face clamping between the annular planar face 22, which delimits the locating pin 14, of the first component 10, and the end face 24, which delimits the receiving sleeve 16, of the second component 12. The locating pin 14 has a substantially cylindrical lateral surface 26 onto which is plugged, in the region of its root 28, a centering ring 29 with an outer cone part 30 which diverges toward the planar face 22. At the other side, the receiving sleeve of the second component 12 has a substantially cylindrical inner face 32 which is embodied as a locating bore and which merges into an inner cone part 34 which diverges toward the end face 24.

A peculiarity of the invention is that the centering ring 29 which is arranged in the root region of the locating pin 14 is elastically deformable, that is to say is composed of an elastically bendable material, preferably of spring steel. Said centering ring 29 is plugged onto the locating pin and is connected to the latter in a form-fitting and/or force-fitting manner. For this purpose, the locating pin 14 has an encircling open-edged recess 36 for receiving the centering ring 29, which recess 36 extends into an axial undercut 37 in the annular planar face 22 of the first component 10. The open-edged recess 36 has an oversize with respect to the centering ring ˜29 which permits the elastic deformation of the latter.

As indicated in FIG. 2b, the cone angle of the sleeve-side inner cone part 34 is, when the locating pin is loose, steeper than the cone angle of the centering-ring-side outer cone 30. During the joining process, the receiving sleeve 16 therefore abuts with the end edge of its inner cone 34 firstly against the outer cone 30 of the centering ring 29, so that the centering ring can, during the clamping process, bend inward in the vicinity of its end side, and the cone angle of the centering ring 29 is aligned with the cone angle of the outer cone. When the locating pin 14 is clamped, there is finally areal contact between the inner cone 34 of the receiving sleeve 16 and the outer cone 30 of the centering ring 29.

The exemplary embodiments as per FIGS. 2, 3 and 4 differ substantially in the inner contour of the centering ring 29 and the outer contour of the associated open-edged recess 36 and of the undercut 37 in the locating pin. In all three cases, a sealing ring 38 composed of elastomeric material is situated between the centering ring 29 and an adjacent face of the locating pin 14. In the case of FIGS. 2a and b, a sealing ring 38 which is embodied as an O-ring is provided, which sealing ring 38 radially covers the free intermediate space between the centering ring 29 and the locating pin and, there, forms a type of tilting axis. During the joining process, the centering ring 29 is deformed by means of the tilting axis formed by the sealing ring 38. The spring part 60, which engages into the undercut 37, of the centering ring 29 is moved radially inward during the joining process, so that the two cone angles are aligned.

In the embodiment variant as per FIGS. 3a and b, the centering ring 29 has an annular base part 64 which bears against a cylindrical centering section 62, and a spring part 60 which projects axially beyond the base part 64 and engages into the open-edged recess 36 and into the undercut 37. The centering ring is, with its base part 64, plugged or shrunk onto the centering section 62 of the locating pin 14 without play. In the region of the spring part 60, the centering ring has an annularly encircling bending zone 66 which is formed by a material thinning and which ensures that, during the joining process, the spring part 60 is bent radially inward in the undercut 37 under the action of the clamped-on receiving sleeve 16. There, the seal 38 is arranged at the end side on the spring part 20 and, at the other side, bears against the base of the undercut 37. In addition, the undercut 37 has a run-on bevel 68 onto which the spring part 60 can run with a complementary oblique face 70 during the joining process.

The embodiment variant shown in FIGS. 4a and b provides a base part 64 which is shortened in relation to FIGS. 3a and b and with which it bears with fitting accuracy on the centering section 62 of the locating pin 14. Here, the sealing ring 38 is situated directly adjacent to the base part 64 and abuts with its one edge against a delimiting step 72 of the recess 36. Said arrangement of the sealing ring 38 has the advantage that a small free space 74 remains between the spring part 60 and the base of the undercut 37, which free space 74 ensures that the spring part 60 can, with its oblique face 70, run freely on the run-on bevel 68 during the joining process. There, too, a bending zone 66 formed by a material thinning 66 is provided which becomes active during the joining process.

In order to improve the bendability of the centering ring 29, it is possible to provide spreading or bending slots 76, 78 which are arranged so as to be distributed over the periphery and are open either axially toward the base part edge and/or toward the spring part edge (cf. FIGS. 5a to c).

The embodiment variants, shown in FIGS. 6a and b and also 7a and b, of a coupling point between two components 10 and 12 differ from the exemplary embodiments as described above primarily in that the centering ring 29 bears sealingly, both at its base part 64 and also at its spring part 60, against the adjacent component, so that no additional sealing ring is necessary in this case. There, the centering ring 29 has an annular base part 64 which is connected to the locating pin in a form-fitting, force-fitting and/or cohesive fashion, and an annular spring part 60 which axially adjoins the base part, projects freely beyond the locating pin and, during the joining process, bears sealingly against the inner cone 34 of the receiving sleeve 16. In both cases, the centering ring 29 is, with its base part 64, latched, shrunk, adhesively bonded, welded or soldered onto the locating pin. In the case of FIGS. 6a and b, the spring part 60 is integrally formed on that side of the base part which faces toward the locating pin root 28, while in the case of FIGS. 7a and b, said spring part 60 is formed on that side of the base part 64 which faces away from the locating pin root 28. In both cases, the locating pin can also be of cylindrical or slightly stepped-cylindrical design in the root region, so that by omitting the centering ring 29, compatibility is created with conventional tool connections of said type which have a cylindrical locating pin.

In the embodiment variants as per FIGS. 8a, b to 15a, b, the centering ring 29 has a cage ring 110 which is composed of a deformable, preferably elastomeric material and which is fitted with support balls 112 which are arranged so as to be distributed in the peripheral direction. The support balls 112, in the joined state of the components 10, 12, bear against the delimiting walls 30′, 34′ which face toward one another. In the exemplary embodiments as per FIGS. 8a, b to 12a, b, the delimiting walls 30′ and 34′ are in each case of conical design in the sense of an outer cone part and an inner cone part on the relevant components. In the exemplary embodiments as per FIGS. 13a and b to 15a and b, only one of the two delimiting walls is of conical design in this sense, while the other delimiting wall runs cylindrically without the centering function thereby being lost. During the joining process, the support balls 112 ensure that the centering ring can perform a rolling movement on the delimiting faces which counteracts uncontrolled clamping in said region. FIG. 16 shows the arrangement of the cage ring 110 with the support ring 112 in a diagrammatic illustration of the receiving sleeve 16 on the component 12.

In the case of FIGS. 8a and b, the principle of the centering ring 29 with support balls 112 is shown without preference of the one or the other component with regard to fixing of the cage ring 110. It can be seen in particular in FIG. 8b that the elastomeric cage ring still has, in the region which it spans, sufficient air space for a deformation which is necessary for the adaptation of the cage ring during the course of the joining process. In all the embodiment variants 8a to 15b, the undercut 37 for receiving the cage ring 110 is situated on the side of the receiving sleeve 16.

In order to obtain a clear assignment between the centering ring 29 and component, in the case of FIGS. 9a and b and 10a and b, the cage ring 110 is latched with in each case one latching rib 116′, 116″ in an annular groove 118′, 118″ of the receiving sleeve 16. In the exemplary embodiment as per FIGS. 11a and b, a latching rib 116′″ is arranged on the cage ring 110, which latching rib 116′″, in: the assembled state, is latched into a complementary annular groove 120 of the locating pin 14.

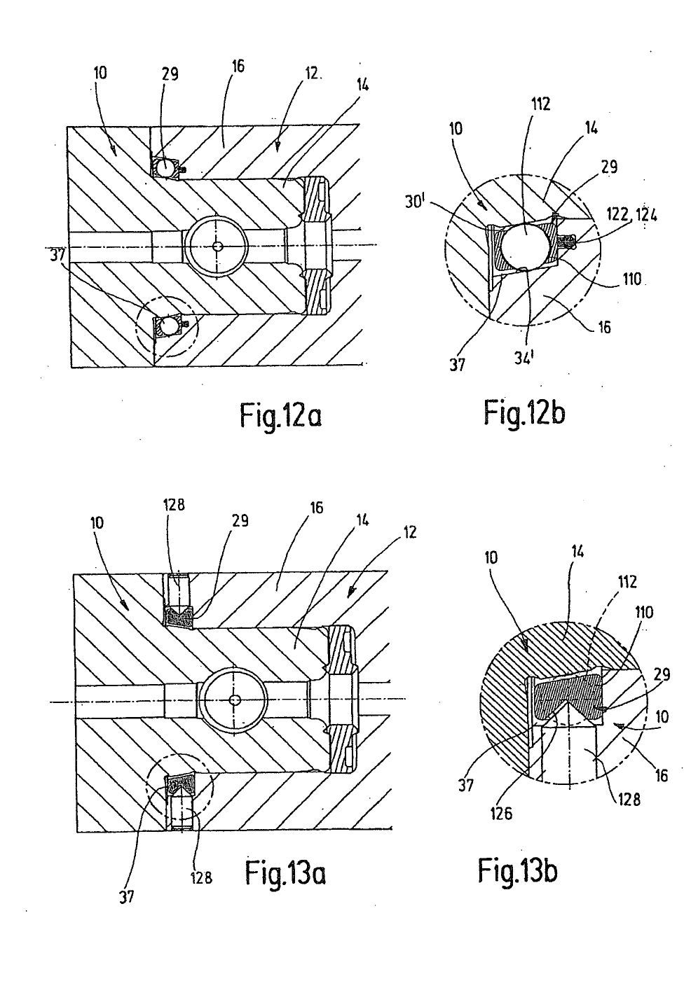

In the exemplary embodiment as per FIGS. 12a and b, latching pins 122 which are arranged on the cage ring 110 so as to be distributed over the periphery are provided, which latching pins 122 are latched in complementary recesses 124 of the receiving sleeve 16.

In the exemplary embodiment as per FIGS. 13a and b, the cage ring 110 is provided with radially outwardly pointing recesses 126 which are conical in the exemplary embodiment and into which holding screws 128, which engage from the outside through the wall of the receiving sleeve 16, engage with their cone tip.

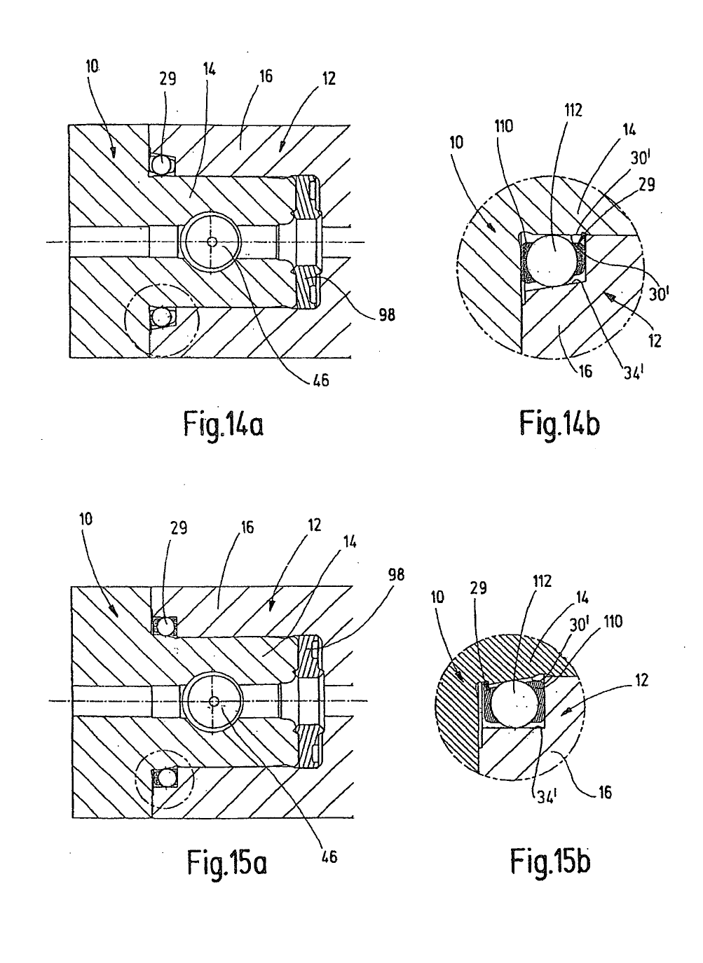

In the exemplary embodiment as per FIGS. 14a and b and 15a and b, it is shown that, of the delimiting walls 30′, 34′ of the locating pin and of the receiving sleeve, only one need be of conical design, while the other can be cylindrical. In the connecting arrangement as per FIGS. 14a and b, it is possible to use components 10 with conventional locating pins.

The clamping mechanism 20 as per FIGS. 1 to 16 comprises a clamping or pendulum bolt 46, which is movably arranged in a transverse bore 44 of the locating pin 14, and two holding screws 52, 54 which are screwed into internal threads 48, 50 of the second component 12 and which are situated diametrically opposite one another. Here, the holding screw 52 is formed as a stop screw which is fixed with its head 56 on the second component 12, while the holding screw 54 forms a movement screw. The clamping bolt 46 engages with its outer cone 78 into an inner cone 80 of the adjacent stop screw 52, and has, at its end situated opposite the outer cone 78, an inner cone 82 for receiving an outer cone 84 which is integrally formed on the movement screw 54.

In order to produce a connection between the two components 10, 12, firstly the locating pin 14 is inserted, when the movement screw 54 is unscrewed, loose into the receiving sleeve 16 of the second component 12. As the movement screw 54 is subsequently screwed into the internal thread 50, there is firstly abutment between the movement screw 54 and the clamping bolt 46 in the region of the conical faces 82, 84 which face toward one another. During the further course of the clamping process, the clamping bolt 46 is inserted with its outer cone 78 into the inner cone 80 until it abuts against the stop screw 52. In this state, the actual clamping process begins, in which the clamping forces introduced by the holding screws 52, 54 are converted, via the conical contact faces 78, 80, 82, 84 of the clamping mechanism 20, axial forces which pull the locating pin 14 into the receiving sleeve 16. The axial forces lead firstly to bending of the spring part 60 of the centering ring 29 by means of the inner cone part 34 of the receiving sleeve 16 until the end face 24 of the receiving sleeve 16 bears against the planar face 22 of the locating pin 14. As the movement screw 54 is further tightened, there is finally planar face clamping between the end face 24 and the planar face 22. The outer and inner cone parts 30, 34, which bear against one another, of the centering ring 29 and of the receiving sleeve 16 ensure precise centering of the components 10, 12 and eliminate the play present in the region of the cylinder fit and the asymmetry present in the clamping mechanism 20.

In the exemplary embodiments shown, a sealing ring 98 which is provided with an axial aperture 96 is situated between the end side of the locating pin 14 and the base of the receiving sleeve 16, which sealing ring 98 seals off a coolant duct 100, which is conducted through the coupling device, to the outside. The coolant duct 100 which passes from the second component opens out through the sealing ring 98 into a coolant tube 102 which is inserted, without a step, through the clamping mechanism 20.

The clamping mechanism 20 plays only a secondary role in the invention. For example, it is also possible, as per FIG. 17, for a clamping mechanism to be provided in which a tension bolt 136 which projects axially beyond the locating pin 14 at the end side to be provided on the component 10, which tension bolt 136, during the joining process, extends through a base opening in the receiving sleeve 16 and is grasped by a machine-side pull-in mechanism (not illustrated here). The centering between the two components 10, 12 takes place here by means of a centering ring 29 which, in the exemplary embodiment shown in FIG. 17, is embodied as a cage ring 110 with support balls 112.

In summary, the following is to be noted: the invention relates two a device for coupling two components 10, 12, for example to tool parts. The first component 10 has a cylindrical locating pin 14 and a radially projecting planar face 22 which delimits the locating pin at its root 28, while the second component 12 has a receiving sleeve 16 with a cylindrical inner face 32. Also provided is a clamping mechanism 20 which, during the clamping process, ensures that the locating pin 14 is pulled into the receiving sleeve 16 and, here, the planar face 22 and the end face 24 are pressed against one another. In order to ensure precise centering of the components using simple means, it is proposed according to the invention that the receiving sleeve inner cone part 34 which diverges from the cylindrical inner face toward the end face, and the locating pin supports an elastically deformable centering ring 29 which is arranged in its root region and which has an outer cone part which is complementary to the inner cone part 34.

1. A device for coupling two components, in particular two tool parts, having a locating pin which is arranged on the first component and has a substantially cylindrical lateral surface, and having a radially projecting annular planar face which delimits the locating pin at its root, having a receiving sleeve which is arranged on the second component and has a cylindrical inner face and is delimited by an annular end face, and having a clamping mechanism which pulls the locating pin into the receiving sleeve and, here, presses the planar face and the end face against one another, with the receiving sleeve having an inner cone part which diverges from the cylindrical inner face toward the end face, and with the locating pin supporting an outer cone part which is complementary thereto, and with an at least partially elastically deformable centering ring which has the outer cone part being arranged in the root region of the locating pin, wherein the centering ring has an annular base part which is connected to the locating pin in a form-fitting, force-fitting and/or cohesive fashion, and an annular spring part which axially adjoins the base part, projects freely beyond the adjacent lateral surface of the locating pin and supports the outer cone part.

2. The device as claimed in claim 1, wherein the centering ring is, with its base part, latched, shrunk, adhesively bonded, welded and/or soldered onto the locating pin.

3. The device as claimed in claim 1, wherein the spring part is integrally formed on that side of the base part which faces toward the locating pin root.

4. The device as claimed in claim 1, wherein the spring part is integrally formed on that side of the base part which faces away from the locating pin root.

5. The device as claimed in claim 1, wherein the centering ring is plugged onto the locating pin.

6. The device as claimed in claim 1, wherein the centering ring is connected to the locating pin in a form-fitting and/or force-fitting manner.

7. The device as claimed in claim 1, wherein an open-edged recess, which surrounds the locating pin, for receiving the centering ring.

8. The device as claimed in claim 7, wherein the open-edged recess extends into an axial undercut in the annular planar face of the first component.

9. The device as claimed in claim 7, wherein the open-edged recess has an oversize with respect to the centering ring which permits the elastic deformation of the latter.

10. The device as claimed in claim 1, wherein the centering ring is composed of resiliently elastic material, preferably of spring steel.

11. The device as claimed in claim 1, wherein the locating pin has a cylindrical centering section which is arranged at an axial distance from the planar face, which cylindrical centering section is adjoined in the direction of the planar face, preferably via a delimiting step, by an open-edged recess with smaller diameter than the centering section.

12. A device for coupling two components, in particular two tool parts, having a locating pin which is arranged on the first component and has a substantially cylindrical lateral surface, and having a radially projecting annular planar face which delimits the locating pin at its root, having a receiving sleeve which is arranged on the second component and has a cylindrical inner face and is delimited by an annular end face, and having a clamping mechanism which pulls the locating pin into the receiving sleeve and, here, presses the planar face and the end face against one another, with the receiving sleeve having an inner cone part which diverges from the cylindrical inner face toward the end face, and with the locating pin supporting an outer cone part which is complementary thereto, wherein the locating pin has a cylindrical centering section which is arranged at an axial distance from the planar face, which cylindrical centering section is adjoined in the direction of the planar face, preferably via a delimiting step, by an open-edged recess with smaller diameter than the centering section.

13. The device as claimed in claim 12, wherein a centering ring has an annular base part which bears against the centering section, and a spring part which projects axially beyond the base part and can be at least partially bent into the open-edged recess.

14. The device as claimed in claim 13, wherein the base part of the centering ring has a centering opening which is matched in diameter to the centering section of the locating pin and whose inner diameter is smaller than the inner diameter of the spring part.

15. The device as claimed in claim 13, wherein the centering ring has, in the region of the spring part, an inner diameter which is variable over its axial extent.

16. The device as claimed in claim 1, wherein the centering ring is, with its base part, plugged or shrunk onto the locating pin without play.

17. The device as claimed in claim 1, wherein the locating pin has, in the region of the undercut, a run-on bevel, which points in the direction of the component axis, for the spring part of the centering ring.

18. The device as claimed in claim 1, wherein the centering ring has, in the region of the spring part, an annularly encircling bending zone formed by a material thinning.

19. The device as claimed in claim 1, wherein at least one sealing ring, composed of elastomeric material, which is enclosed in an annular intermediate space between the locating pin and the centering ring.

20. A device for coupling two components, in particular two tool parts, having a locating pin which is arranged on the first component and has a substantially cylindrical lateral surface, and having a radially projecting annular planar face which delimits the locating pin at its root, having a receiving sleeve which is arranged on the second component and has a cylindrical inner face and is delimited by an annular end face, and having a clamping mechanism which pulls the locating pin into the receiving sleeve and, here, presses the planar face and the end face against one another, with the receiving sleeve having an inner cone part which diverges from the cylindrical inner face toward the end face, and with the locating pin supporting an outer cone part which is complementary thereto, wherein at least one sealing ring, composed of elastomeric material, which is enclosed in an annular intermediate space between the locating pin and the centering ring.

21. The device as claimed in claim 20, wherein the sealing ring is integrally vulcanized on the locating pin and/or on the centering ring.

22. The device as claimed in claim 1, wherein the centering ring has spreading or bending slots which are arranged so as to be distributed over the periphery and are open axially toward the base part edge and/or toward the spring part edge.

23. The device as claimed in claim 20, wherein the cone angle of the sleeve-side inner cone is, when the locating pin is loose, steeper than the cone angle of the centering-ring-side outer cone.

24. The device as claimed in claim 23, wherein the cone angle of the outer cone and of the inner cone are aligned with one another when the centering ring is clamped over the locating pin.

25. The device as claimed in claim 1, wherein the centering ring, in the clamped state, bears annularly, in the region of the base part, at the inside against the centering section of the locating pin, in the region of the spring part, at the outside against the inner cone of the receiving sleeve, and in the region of the locating pin root, at the end side against an undercut face.

26. The device as claimed in claim 1, wherein the centering ring has a cage ring which is composed of elastically deformable material and in which are embedded support bodies which are arranged so as to be distributed in the peripheral direction and which are supported against the locating pin and in the receiving sleeve.

27. A device for coupling two components, in particular two tool parts, having a locating pin which is arranged on the first component and has a substantially cylindrical lateral surface, and having a radially projecting annular planar face which delimits the locating pin at its root, having a receiving sleeve which is arranged on the second component and has a cylindrical inner face and is delimited by an annular end face, and having a clamping mechanism which pulls the locating pin into the receiving sleeve and, here, presses the planar face and the end face against one another, with the receiving sleeve and/or the locating pin having a cone part which diverges from its cylindrical lateral surface or inner face toward the end or planar face, which cone part is embodied as an inner cone part in the case of the receiving sleeve and as an outer cone part in the case of the locating pin,
wherein an annularly encircling pocket which is formed into the receiving sleeve and/or into the locating pin is provided between the receiving sleeve and the locating pin in the region of the at least one cone part, in which pocket is arranged a cage ring which is composed of elastically deformable material and which is fitted with support bodies which are arranged so as to be distributed in the peripheral direction and which, in the joined state, are supported against the delimiting walls, which face towards one another in the region of the pocket, of the receiving sleeve and of the locating pin.

28. The device as claimed in claim 27, wherein the cage ring is composed of an elastomeric material, while the support bodies which are arranged in the cage ring are embodied as support balls.

29. The device as claimed in claim 27, wherein the support bodies are composed of metal, preferably of steel.

30. The device as claimed in claim 27, wherein the cage ring is connected in a form-fitting and/or force-fitting manner to one of the two components.

31. The device as claimed in claim 30, wherein the cage ring is latched, clamped or screwed onto one of the two components.

32. The device as claimed in claim 27, wherein the support bodies are supported on the at least one cone part.

33. The device as claimed in claim 27, wherein the encircling pocket is formed into the receiving sleeve and the cage ring is fixed in said pocket.

34. The device as claimed in claim 1, wherein the clamping mechanism has a clamping bolt which is movably arranged in a transverse bore of the locating pin and which has, at its ends, an inner or outer cone, and two clamping elements which are situated diametrically oppositely with respect to the cylindrical inner face of the receiving sleeve, which, during the clamping process, can be clamped in a wedged fashion to the clamping bolt under bending of the centering ring and under mutual pressing of the components in the region of the planar face, and which are preferably embodied as holding screws.

35. The device as claimed in claim 1, wherein the clamping mechanism has a tension bolt which projects axially beyond the end-side end of the locating pin, and also a pull-in device which is arranged at the machine side and which engages axially on the tension bolt through a passage opening in the receiving sleeve.

36. The device as claimed in claim 1, wherein an axial seal which is provided with an aperture is arranged between the end side of the locating pin and the base of the receiving sleeve.
